(19) United States
(12) Patent Application Publication
(10) Pub. No.: US 2002/0123935 A1
(43) Pub. Date: Sep. 5, 2002

(54) Secure commerce system and method

(76) Inventors: Nader Asghari-Kamrani, Centreville, VA (US); Kamran Asghari-Kamrani, Centreville, VA (US)

Correspondence Address: Richard C. Litman, LITMAN LAW OFFICES, LTD., P.O. Box 15035, Arlington, VA, 22215, US

(21) Appl. No.: 09/796,675

(22) Filed: Mar. 2, 2001

(51) Int. Cl. G06F 17/60

(52) U.S. Cl. 705/26

(57) ABSTRACT

A secure commerce system and method to increase security in Internet-based, phone-based, interactive television-based, mobile-based and wireless-based commerce utilized by a customer(s) to order goods and services from a merchant(s) or to pay bills. The system includes a customer's financial institution that assists the customer to pay bills or to purchase the ordered goods and services and a business entity issuing a secure commerce card number (SCCN) for the customers to pay bills or to purchase the ordered goods and services without revealing confidential financial information. Communications devices are available for the customer, the merchant, the customer's financial institution and the business entity to give and receive information between each other. The method utilizes currently available computer, telephone, mobile and wireless technology, which includes use of the Internet, personal computers, public and private networks, telephones, pagers, mobile and wireless devices and personal digital assistants (PDAs).

### BACKGROUND OF THE INVENTION

1. Field of the Invention

The present invention relates to a system and method to increase security in Web-based, interactive television, mobile, wireless and phone-based commerce.

2. Description of the Related Art

The increasing use of the Internet and the increase of businesses utilizing telemarketing sales have lead to a dramatic increase in customers releasing confidential financial information, in the form of credit card numbers and checking account numbers, to electronically purchase desired goods and services. The effect of these increases are reflected in the related art.

U.S. Pat. No. 5,715,314 issued to Payne et al. outlines the use of a network-based sales system which includes at least one buyer computer for operation by a user desiring to buy a product or service. There is also at least one merchant computer and at least one payment computer. The buyer computer, the merchant computer and the payment computer are interconnected by a computer network. The buyer computer is programmed to receive a user request for purchasing a product or service and to produce a payment message to be sent to the payment computer that comprises a product identifier identifying the product or service provided.

U.S. Pat. No. 5,732,137 issued to Aziz outlines a system and method for providing remote user authentication in a public computer network such as the Internet. More specifically, the system and method provides for remote authentication using a onetime password scheme having a secure out-of-band channel for initial password delivery.

U.S. Pat. No. 5,732,400 issued to Mandler et al. outlines the use of a system and method for enabling on-line transactional services among sellers and buyers having no previous relationship with each other. The system includes a financial clearinghouse for receiving a request for goods or services from a buyer and making a real-time determination of a risk classification of the buyer utilizing an on-line repository of credit information.

U.S. Pat. No. 5,757,917 issued to Rose et al. outline the use of a quasi-public network, such as the Internet, to enable users of the network to conduct commercial transactions involving a payment of funds by one user to another user of the network. Upon receiving a message over the network from a qualified user-seller, a message is sent over the network to the user-buyer that was identified in the message from the user-seller. The message to the user-buyer requests confirmation of a transaction identified in the message received from the user-seller. Upon receiving a confirmation over the network from the user-buyer, payment information is sent by secure channels off the network to an agent of the user-seller.

U.S. Pat. No. 5,809,144 issued to Sirbu et al. outlines the use of a system and method that is optimized for the sale and delivery of low-priced digitized goods available on a network. The system and method is equally well suited for the sale and delivery of high priced digital goods as well. The system and method is particularly useful for the sale and delivery of low priced digitized goods because of the unique problems associated with low-priced digitized goods. The system and method can also be used for the sale and delivery of non-digitized goods.

U.S. Pat. No. 5,815,665 issued to Teper et al. outlines the use of a system and method for enabling consumers to anonymously, securely and conveniently purchase on-line services from multiple service providers over a distributed network, such as the Internet. Specifically, a trusted third-party broker provides billing and security services for registered service providers via an online brokering service, eliminating the need for the service providers to provide these services.

U.S. Pat. No. 5,826,241 issued to Stein et al. outlines the use of a payment system for enabling a first Internet user to make a payment to a second Internet user, typically for the purchase of an information product deliverable over the Internet. The front end portion of the payment system queries the first user over the Internet whether to proceed with payment to the second user. If the first user replies affirmatively, a charge to the first user is processed off the Internet. However, if the first user replies negatively, the first user is not charged for the information product.

U.S. Pat. No. 6,014,646 issued to Vallee et al. outlines the use of a method for making a payment using an account manager or kiosk, the method guaranteeing the payment of the supplier and the anonymity of the customer. A customer withdraws from his financial institution a sum in the form of blind electronic coins and cash and deposits the latter in one or more anonymous accounts in a kiosk that uses the account(s) for paying the suppliers of the goods and services.

Although each of the previous patents outline a valuable system and method, what is really needed is a system and method that allows for increased security for not only Web-based shopping, but also for telephone, interactive television, mobile and wireless-based commerce. Such a flexible and accommodating system and method would be of great value to the many persons who would like to partake and utilize phone-based, Internet-based, interactive television-based, mobile-based and wireless-based commerce.

None of the above inventions and patents, taken either singularly or in combination, is seen to describe the instant invention as claimed. Thus a secure commerce system and method solving the aforementioned problems is desired.

### SUMMARY OF THE INVENTION

The invention is a system and method to increase security in Web-based, interactive television, mobile, wireless and phone-based commerce utilized by a customer(s) to order goods and services from a merchant(s). The system includes a customer's financial institution that assists the customer to purchase the ordered goods and services and a business entity issuing a secure commerce card number (SCCN) for the customers to purchase the ordered goods and services without revealing confidential financial information. There are also communications devices for the customer, the merchant, the customer's financial institution and the business entity to give and receive information between each other. The method utilizes currently available computer and telephony technology, which includes use of the Internet, personal computers, public and private telephone networks, telephones, pagers and personal digital assistants (PDAs).

Accordingly, it is a principal object of the invention to reduce fraud and increase security for Web-based, phone-based, interactive television, mobile and wireless-based commerce.

It is another object of the invention to keep customers satisfied by worry-free payment processing, which translates into more sales transactions for merchants.

It is a further object of the invention to protect the customer from getting bills for goods and services that were not ordered.

Still another object of the invention is to shop using Web-based, phone-based, interactive television-based, mobile-based and wireless-based technology without giving personal data and confidential financial information.

It is another object of the invention is to simplify and secure providing services, such as bill payment, gift certificates, credit report services, fund transfers and exchange services.

It is another object to decrease damages to the customer, merchants and financial institutions.

It is an object of the invention to provide improved elements and arrangements thereof for the purposes described which is inexpensive, dependable and fully effective in accomplishing its intended purposes.

These and other objects of the present invention will become readily apparent upon further review of the following specification and drawings.

### BRIEF DESCRIPTION OF THE DRAWINGS

FIG. 1A is an overview of a secure commerce system according to the present invention.

FIG. 1B is a block diagram of a secure commerce method according to the present invention.

FIG. 2 is a block diagram of the registration of a customer utilizing a secure commerce method according to the present invention.

FIG. 3 is a block diagram of the transaction of a customer utilizing a secure commerce method according to the present invention.

FIG. 4 is a block diagram of the order and payment of a customer utilizing a secure commerce method according to the present invention.

FIG. 5 is a block diagram of a customer confirming an order utilizing a secure commerce method according to the present invention.

FIG. 6 is a block diagram of a customer's financial institution authorizing payment utilizing a secure commerce method according to the present invention.

FIG. 7 is a block diagram of a secure commerce card number issuer authorizing a customer utilizing a secure commerce method according to the present invention.

Similar reference characters denote corresponding features consistently throughout the attached drawings.

### DETAILED DESCRIPTION OF THE PREFERRED EMBODIMENT

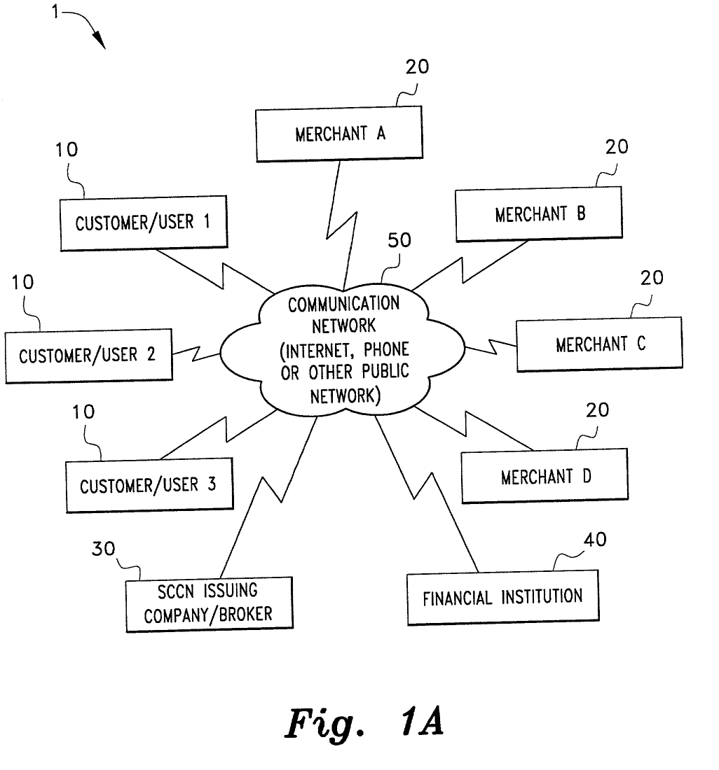

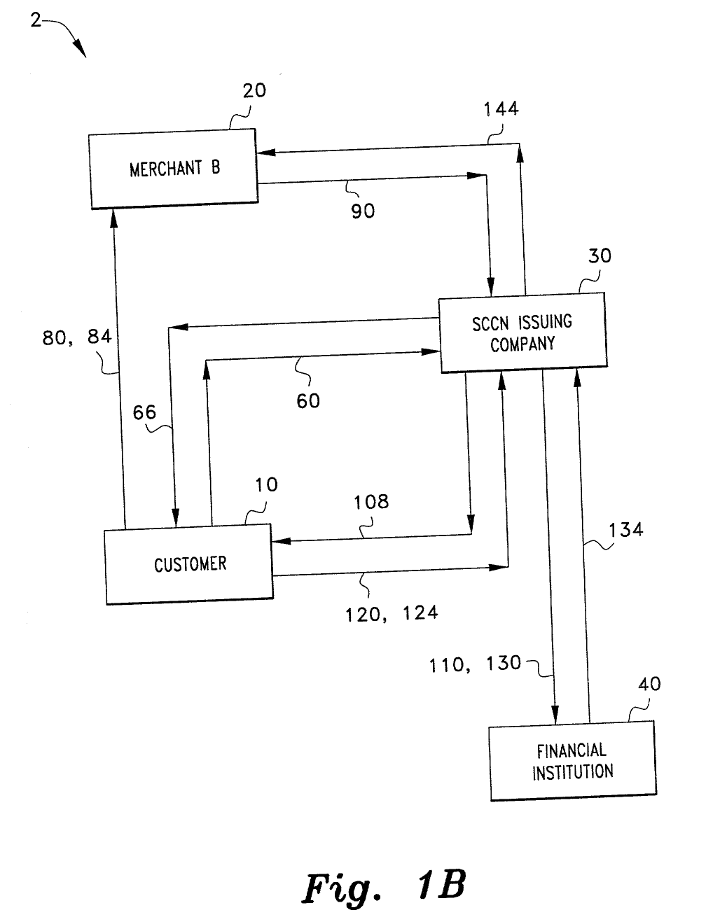

The present invention relates to a system 1 and method 2 to increase security in Internet-based, phone-based and interactive television-based, mobile-based and wireless-based commerce. FIG. 1A illustrates a system 1 to increase security in Internet-based, interactive television-based, mobile-based and wireless-based commerce utilized by a customer(s) or user(s) 10 to order goods and services from a merchant(s) 20.

One of the major differences between this system 1 and method 2 and those found in the related art is that the customer 10 is directly involved with the authorization process, which gives the customer 10 more control over the payment. This is not only beneficial to the customer 10, but also to the merchants 20. The reason more online transactions are fraudulent is that they are all what is called “card not present” transactions.

In a “card present” transaction, a clerk can at least compare the signature on the back of the credit card with the signature obtained on the sales slip at the time of transaction. That protection is not available in card not present transactions. For those transactions, credit card companies and their partners force merchants 20 to pay higher premiums for processing orders. When a sale turns out to be fraudulent, the card issuer withdraws the funds from the merchant's 20 bank account automatically. The true cardholder and the merchant 20 typically are liable for this transaction. This system 1 and method 2 involves the customer 10 in the authorization process and requests transaction confirmation from the customer 10. This confirmation is almost the same as the signature on the sales slip.

The system 1 comprises a plurality of customers 10, a plurality of merchants 20 with goods and services that are desired by the customers 10, a customer's financial institution 40 that assists the customer 10 to purchase the ordered goods and services and a business entity issuing a secure commerce card number (SCCN) 30 for the customers 10 to purchase the ordered goods and services without revealing confidential financial information.

It would be desirable to develop a new payment method that minimizes or eliminates the use of these traditional payment methods during shopping over a communication network. This would improve the customers' trust and reduce his fear of fraud, which would lead to more shopping. Ideally, a secure commerce model would prevent customers 10 from using his personal data and confidential financial information at the time of ordering and would also involve the customer 10 more in the authorization process.

The present invention relates to a system 1 and method 2 to support this ideal commerce model. A secure commerce card number is used at the time of ordering, instead of providing a customer's 10 personal data and confidential financial information to a merchant 20. A series of steps describing the overall method 2 are conducted between the customer 10, the merchant 20, the SCCN issuing company 30 and the customer's financial institution 40 and are outlined in FIG. 1B.

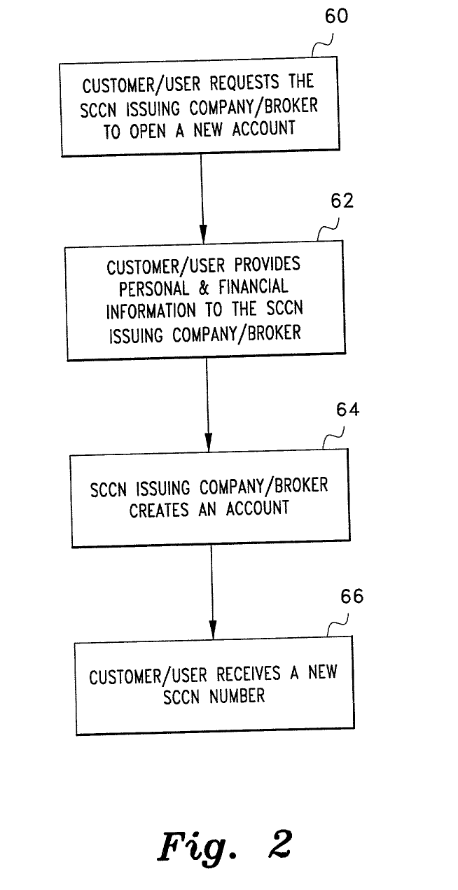

There are three distinct phases involved in using the secure commerce card number, the first of which being the registration phase, which is depicted in FIG. 2. During the registration phase, the customer 10 requests a secure commerce card number from the SCCN-issuing company 30 to open a new account 60. The issuing company 30 asks the customer 10 about his personal data and confidential financial information 62 and assigns him a SCCN-number.

The SCCN issuing company 30 stores the customer's 10 SCCN number, personal data and confidential financial information in a secure location and creates an account for the new customer 10, 64. The SCCN number is the number assigned to the customer's 10 account and each customer 10 can register for one or more SCCN-numbers. After the one time registration, the account owning customer 10 receives his new SCCN-number 66, which is ready to be used for Internet-based, phone-based, interactive television-based, mobile-based and wireless-based commerce.

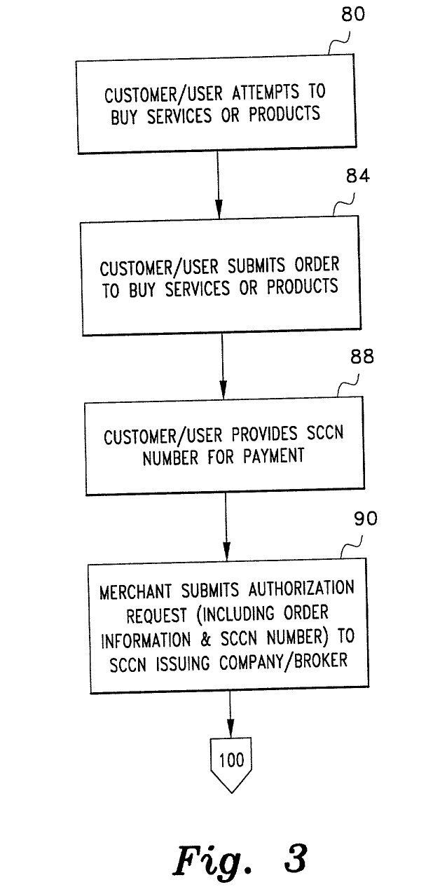

Next is the transaction phase, where the customer 10 attempts to buy services or products 80, as illustrated in FIG. 3. The customer 10 provides his SCCN-number and name of the SCCN-issuing company 30 to the merchant 20 to buy and pay for desired services and products 84, 88. The customer 10 could be the SCCN account owner or any other person who is authorized by the SCCN account owner to use his SCCN-number. An example of this is a parent who authorizes his children to use his SCCN-number to order books or other expenses.

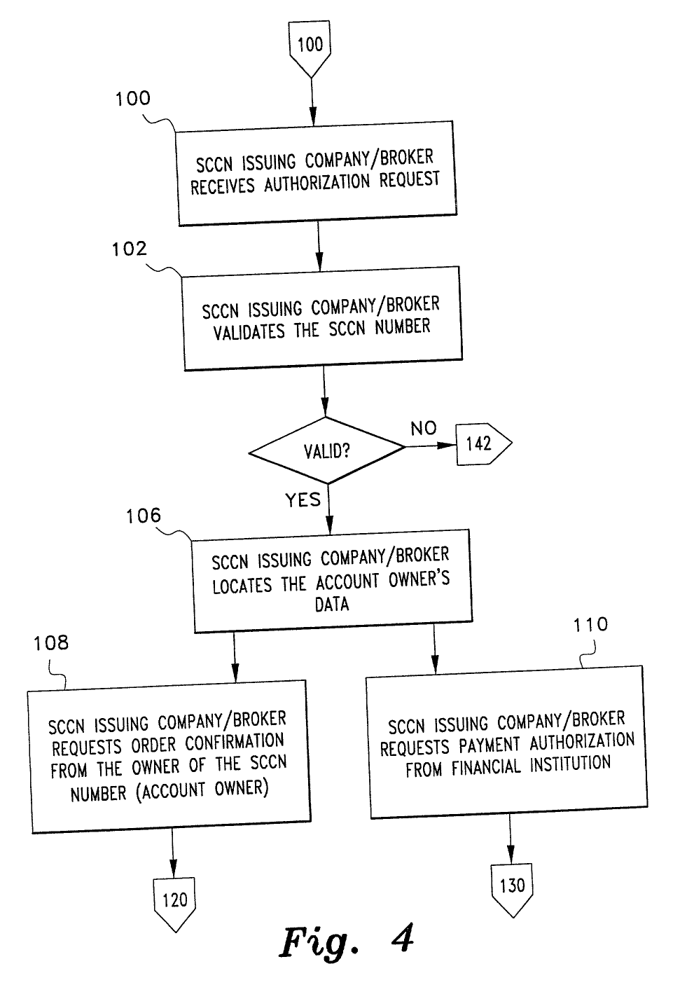

The merchant 20 then submits the authorization request to the SCCN-issuing company 30, 90. The SCCN-issuing company 30 receives the authorization request 100, as depicted in FIG. 4. The authorization request contains information regarding the order and customer SCCN-number. The SCCN-issuing company 30 validates the SCCN-number and locates the customer's 10 data 102, 106 and sends a message to the customer 10 requesting his confirmation related to the order 108. The SCCN-issuing company 30 also submits an authorization request to the customer's financial institution 40, 110. The authorization request can be sent to the financial institution 40 directly or through a payment processing gateway (not shown).

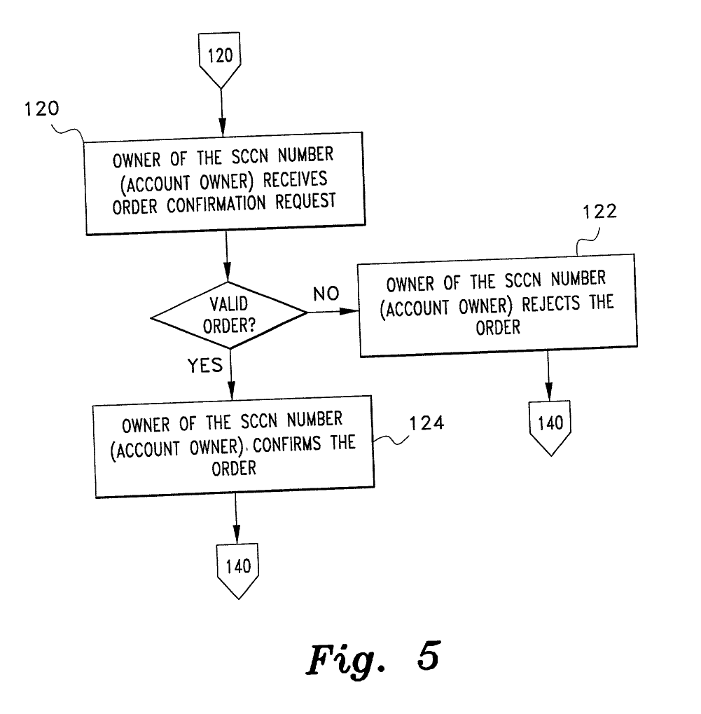

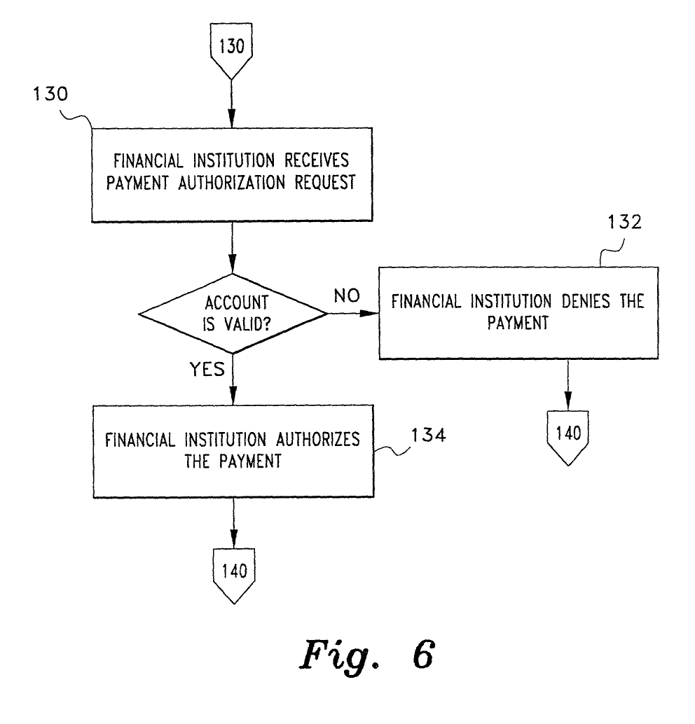

The SCCN-owner 10 receives the order confirmation request 120 and determines if the order is a valid order. The SCCN-owner 10 can reject the order 122 or can confirm the order 124. This is illustrated in FIG. 5. The customer's financial institution 40 then receives the payment authorization request 130 and determines if the request is for a valid account. Note that the customer's financial institution 40 does not validate the order. It only validates the account. In other words, the customer's financial institution 40 can deny the payment 132 or authorize the payment 134, as shown in FIG. 6.

There are some important differences between the system 1 and two key pieces of prior art, U.S. Pat. No. 5,757,917 and U.S. Pat. No. 5,826,241. In those patents, the broker is not authenticating the user and the merchant 20, which is not secure. With the system 1, the SCCN-issuing company 30 will authenticate the SCCN-owner 10. The SCCN-issuing company 30 will authenticate the users before allowing them to do any activity in their account or confirm or reject the order.

In those patents, users will confirm or reject the order by sending an e-mail back to the broker. This way any person other than the SCCN-owner 10 is also able to confirm or reject the order. With the present system 1, the users have to pass the authentication process in order to be able to connect to their account and confirm or reject the order,

Also in those patents, just a part of the user and merchant's 20 information is in a secure location. With the present system 1, all the information regarding the SCCN-owners 10 and merchants 20 will be held in a secure environment.

Also those patents handle transactions which are initiated by persons who have a personal computer connected to the Internet only. With the present system 1, the SCCN-owners can use their SCCN-number to shop anywhere or pay bills over any communications network 50 using any communications device (e.g., ordering goods by telephone).

In those patents, the customers 10 are required to have an e-mail address, because they receive confirmation request messages from a broker by e-mail. The customers 10 also send the response back by e-mail. With the present system 1, the customers are free to use any communication device over any communications network 50.

There are several key features of the system 1. First, the SCCN-issuing company 30 will authenticate the SCCN-owner 10 before accepting his response to the order confirmation request. This means that nobody other than the SCCN-owner 10 is able to confirm or reject the order. This will prevent an unauthorized use of the SCCN number.

Secondly, the SCCN-issuing company 30 will authenticate the SCCN-owner 10 before allowing him to conduct any activity on his account. Note that the SCCN-issuing 30 company could also use different technologies, such as a password, digital signature or biometric information to authenticate the SCCN-owner 10.

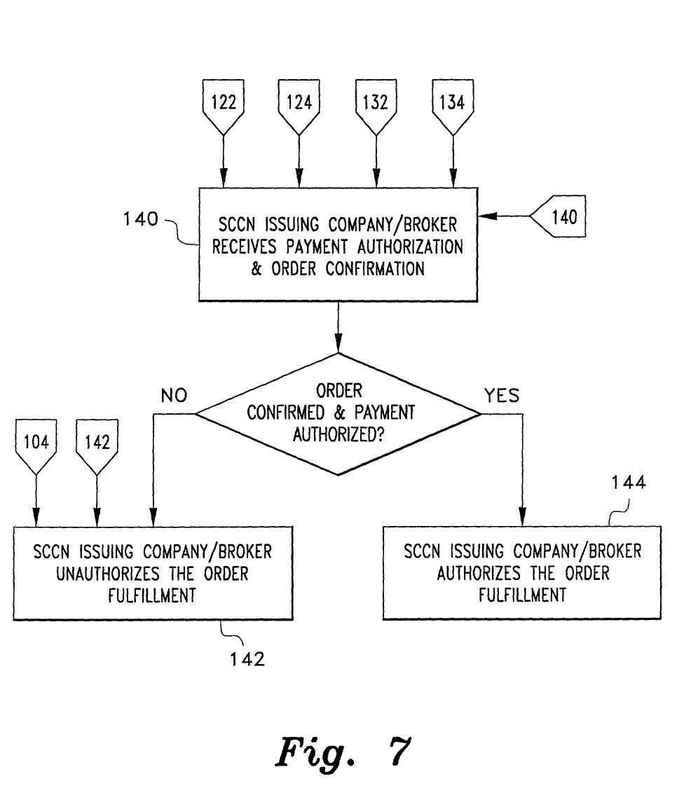

Once the SCCN issuing company 30 receives payment authorization and order confirmation 140, the SCCN issuing company 30 then authorizes the order 144. If the SCCN issuing company 30 does not receive payment authorization from the financial institution or order confirmation from the SCCN-owner 10, then the order fulfillment will be unauthorized 142. This is illustrated in FIG. 7.

The SCCN-issuing company 30 will not authorize an order and a payment until the SCCN-owner's confirmation has been received and the payment has been authorized by the customer's financial institution 40. If the SCCN-owner 10 confirms the order and his financial institution 40 authorizes the payment, then the SCCN-issuing company 30 authorizes the order fulfillment. Otherwise the SCCN-issuing company 30 will reject the order and will not authorize the order fulfillment.

The SCCN-issuing company 30 can be a third party company, a broker or a financial company such as a credit and debit card company or a bank. When a customer's financial institution 40 acts also as the SCCN-issuing company 30, then the authorization process could become easier. An example of this is a credit card company including the user authorization process in its existing credit card processing system. Under these circumstances, the credit card company could request the confirmation of the credit card holder prior to authorizing the payment. However, this will restrict the SCCN-account to only one financial institution 40.

Only the SCCN-issuing company 30 has the customer's 10 personal and confidential financial information. The merchant 20 will not know the customer's 10 personal and confidential information and will simply handle the SCCN-number. An unauthorized user is prevented from using another customer's 10 SCCN-number, since the order has to be confirmed by the customer 10.

The SCCN-issuing company 30 can send messages to the SCCN-owner's account at the SCCN-issuing company 30 or to the SCCN-owner through a number of different messaging techniques, such as e-mail, paging, telecasting, telephone, etc. utilizing Internet-, telephone-, interactive-TV, and mobile and wireless-based technology. The SCCN-owner could confirm and authorize the order using any communication device over any communications network.

The owner of the SCCN-number 10 can also define rules that will be used in the authorization process. When the SCCN-issuing company 30 receives the authorization request from a merchant 20, the SCCN-issuing company 30 will apply these rules prior to authorizing the order. For example, the SCCN-owner 10 can define a rule like “when an order authorization request has been received from mybooks.com and the total amount is less than $100 and the date of the order is between Nov. 10, 2000 and Nov. 11, 2000, confirm it”.

When an order passes this rule, the SCCN-issuing company 30 will skip sending the confirmation request to the SCCN-owner 10 and will assume that the order has been confirmed by the SCCN-owner 10. The SCCN-issuing company 30 will only notify the SCCN-owner 10 regarding this order.

Operation of the system 1 and method 2 is uncomplicated and can be used with current Internet-based, phone-based, interactive television-based, mobile-based and wireless-based technology, which can include the use of the Internet, personal computers, standard telephone technology, e-mail or even personal digital assistants and pagers.

It is to be understood that the present invention is not limited to the embodiment described above, but encompasses any and all embodiments within the scope of the following claims.

We claim:

1. A system to increase security in Internet-based, phone-based, interactive television-based, mobile-based and wireless-based commerce utilized by a customer(s) to order goods and services from a merchant(s); comprising:
a customer's financial institution that assists the customer to purchase the ordered goods and services;
a business entity issuing a secure commerce card number (SCCN) for the customers to purchase the ordered goods and services without revealing confidential financial information; and
communications devices for the customer, the merchant, the customer's financial institution and the business entity to give and receive information between each other.

2. The system according to claim 1, wherein persons are assigned by the SCCN-owner to use the secure commerce card number to purchase the ordered goods and services.

3. The system according to claim 1, wherein said confidential financial information includes credit card numbers, debit card numbers, savings account numbers, Internet bank numbers, money market account numbers, checking account numbers and any other account numbers that can be used for shopping and bill payment.

4. The system according to claim 1, wherein said communications devices include computers, telephones, pagers and wireless and mobile devices.

5. A method to increase security in Internet-based, phone-based, interactive television-based, mobile-based and wireless-based commerce utilized by a customer(s) to order goods and services from a merchant(s); comprising the steps:
the customer registers and applies for a secure commerce card number from a secure commerce card number issuing company;
the customer receives his secure commerce card number assigned to him;
the customer provides his secure commerce card number to a merchant to purchase goods and services;
the merchant submits an authorization request to the secure commerce card number issuing company;
the secure commerce card number issuing company sends the order confirmation request to the SCCN-owner;
the SCCN-owner responds to the confirmation request;
the secure commerce card number issuing company submits an account authorization request to the customer's financial institution;
the customer's financial institution responds back to the authorization request; and
the secure commerce card number issuing company responds back to the merchant.
